(19) United States
(12) Patent Application Publication
(10) Pub. No.: US 2015/0161356 A1
(43) Pub. Date: Jun. 11, 2015

(54) AUTOMATED COACHING

(71) Applicant: NUTRISYSTEM INC., Fort Washington, PA (US)

(72) Inventors: Aditi GOKHALE, New York City, NY (US); Anthony N. FABRICATORE, Wallingford, PA (US); David MACDONALD, Hampton, NJ (US)

(21) Appl. No.: 14/489,388

(22) Filed: Sep. 17, 2014

Related U.S. Application Data
(60) Provisional application No. 61/878,948, filed on Sep. 17, 2013.

(51) Int. Cl. G06F 19/00; G09B 5/00

(52) U.S. Cl. CPC G06F 19/3475; G09B 5/00

(57) ABSTRACT

The present invention provides systems and methods relating to a coaching system, which supports behavioral modification programs for calorie control, weight control, and/or general fitness. Specific embodiments of the invention include a coaching system that is useful in conjunction with a system for monitoring caloric balance (consumption vs. expenditure) of an individual.

### FIELD OF THE INVENTION

The present invention relates to a coaching system which supports behavioral modification programs for calorie control, weight control or general fitness. In particular, the invention, according to one aspect, relates to a coaching system which is useful, for example, in conjunction with a system for monitoring caloric balance (consumption vs. expenditure) of an individual.

### BACKGROUND

Research has shown that health problems in society are caused by, among other things, an unhealthy lifestyle. More and more, in our society people exhibit poor eating habits and a lack of adequate exercise. As a result obesity and excessive body weight have become epidemic. However, more and more people are now convinced that substantial benefits are derived from establishing a healthier lifestyle.

Experience has proven that traditional medicine is not an answer to avoiding the results of an unhealthy lifestyle. There have been efforts to meet the needs of these individuals, including fitness programs, exercise equipment, dietary plans and self-help books. Some of these efforts include a communications mechanism to the individual (user) including a web site which can interact with a user to facilitate effective implementation of a weight control/exercise program. Each of these attempts seeks to empower the individual to take charge and get healthy. Many of these attempts overlook one or more crucial aspects in attaining a healthier lifestyle. Overlooked is the fact that the individual's motivation, mood or outlook, and situation are crucial variables to consider when selecting an effective plan.

For example a user may be assigned both a suggested daily menu and/or an exercise regime, hereinafter a “lifestyle menu”. Notwithstanding the fact that the lifestyle menu may be the result of input from the user, at times the user may become discouraged about the user's ability or commitment to maintain the lifestyle menu. It is well known that the discouragement alone can disrupt the user's good intentions. The invention provides a mechanism for supporting the individual at those very crucial times.

### SUMMARY OF THE INVENTION

The invention provides support and/or brief cognitive and/or behavioral interventions to a user of a lifestyle menu. Intervention or support opportunities arise in at least three different scenarios. In one scenario the user has a period of uncertainty concerning maintaining the lifestyle menu, an active concern that future intended actions will not conform to the lifestyle menu. Specifically the user:

(a) believes it is likely that in the near future the user may engage in a consumption event (eat or drink something) which will exceed an allowable quantity or include a meal or meal element which is not recommended, or

(b) believes it is likely that the user, in the near future, may skip an exercise event or engage in an exercise event but fall short of a desired effort or duration.

Alternatively the user may have a concern (based on something other than a specific future action) related to a feeling or emotion, specifically that:

(c) maintaining the lifestyle is threatened because the user is experiencing a negative or apathetic emotional state, or

(d) maintaining the lifestyle is threatened because the user is experiencing a positive or celebratory emotional state, or

(e) maintaining the lifestyle is threatened because of external stimuli.

Any of these circumstances will be referred to as a “wobble”.

In another scenario the user seeks an intervention because the user has:

(a) engaged in a consumption event (eat or drink something) which will exceed an allowable quantity or include a meal or meal element which is not recommended, or

(b) skipped an exercise event or engaged in an exercise event but fell short of a desired effort or duration or,

(c) done or failed to perform in some other fashion as required to satisfy the lifestyle menu. Any of these underlying events will be referred to as a “slip-up”.

In another scenario the user seeks positive reinforcement because the user has:

(a) avoided what had appeared likely as engaging in a consumption event (eat or drink something) which would have exceeded an allowable quantity or included a meal or meal element which is not recommended, or

(b) engaged in an exercise event,

(c) avoided what had earlier appeared likely as doing or failing to perform in some other fashion as required to satisfy the lifestyle menu. Any of these underlying events will be referred to as a “victory”.

Collectively wobbles, victories and slip-ups are referred to as “moments”.

The invention provides a system, method and computer readable medium for implementing automated coaching relative to a user moment. In automated coaching, the user provides some input specifying a wobble, victory or slip-up and receives a related intervention designed to support the user in maintaining the lifestyle menu, specifically, to avoid negative consequences from the wobble, limit the negative consequences of the slip-up, and/or reinforce the user's choices that led to the victory. The automated coaching system, method and computer readable menu rely exclusively on non-human coaching; i.e., the automated coaching does not rely on human coaches to interact with any user. The automated coaching system of the invention includes a computer capable of communicating with users and programmed to respond to user reports of a wobble, slip-up or victory with questions to develop more information about the reported events and then, based on the current information acquired from the users plus historical information about the users, to respond with coaching instructions for the user.

The automated coaching system or method of the invention relies on a user device to communicate between the user and the system. The automated coaching system includes a computer programmed to provide the automated coaching and related data bases and communication devices which are connected to a network to provide a communication path to/from the user devices.

The system includes or implements:

a receiver for receiving a moment defining message generated by a user, where the message may define one of plural types of moments,

a database or databases storing a plurality of collections of moment responses including at least one collection of moment responses for each of the plural types of moments,

a selector responsive to said receiver for selecting a particular one of said collections of moment responses in dependence on the particular type of moment message received and for using said moment defining message for selecting a response from the particular collection, and

a forwarder for forwarding said selected response to the user.

Alternatively the system includes or implements:

a receiver for receiving a moment defining message generated by a user,

a collection of moment responses,

a transmitter for transmitting at least one qualification message to the user in response to receipt of said moment defining message, said qualification message requesting qualification information respecting the moment represented in the moment defining message,

a qualification receiver for receiving a qualification response from the user,

a selector responsive to said receiver and said qualification receiver for selecting a particular one of said moment responses in dependence on the moment defining message and the qualification response, and

a forwarder for forwarding said selected response to the user.

The invention includes a method implementing the procedures illustrated in the attached drawings and a non-transitory computer readable medium which stores a program which when executed will implement the method described herein.

### BRIEF DESCRIPTION OF THE DRAWINGS

The present invention will now be described in the following portions of the specification and illustrated in the attached drawings in which:

FIG. 1 is a block diagram showing the major components of the automated coaching system;

FIG. 2 is a flow diagram of actions taken by the automated coaching system on receipt of a wobble report;

FIGS. 3A, 3B, 3C, 3D, 3E, and 3F are examples of intervention tables illustrating interventions and their characteristics;

FIG. 4 is an example of the victory response table;

FIG. 5 is an example of the slip-up response table

FIG. 6 is an example of a screen display allowing user response to an intervention in a message bases user device;

FIG. 7 is a flow diagram of actions taken by the automated coaching system on receipt of a slip-up;

FIG. 8 is a flow diagram of actions taken by the automated coaching system on receipt of a victor; and

FIG. 9 is a flow diagram illustrating processing to derive proactive interventions.

### DETAILED DESCRIPTION

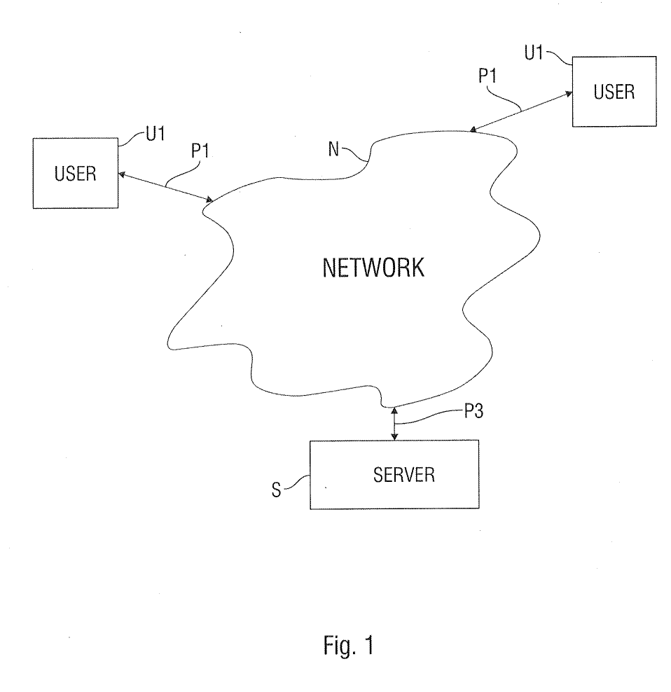

FIG. 1 shows an overview of a system according to the invention. More particularly, a plurality of user devices U1, U2, etc. connect through a network N with a server S through a plurality of paths P1, P2 and P3. The paths may be implemented with wired or wireless technology. The network N may include one or more of any of a wide variety communications networks now in use including the Public Switched Telephone Network (PSTN), the Internet, other wide area or local area computer networks as well as combinations of the foregoing or the like. The modality of the networks includes both wired (using electrical as well as optical transmission) and wireless technology. The user devices U1 or U2 may include any device which is capable of communicating over the network N including wired or wireless telephones, smart phones, computer terminals, tablets, personal digital assistants, computers or the like. Basically the user devices can be message based, i.e., messages are created by a user either typing on a keyboard or selecting icons using a pointer device. Typical devices use a browser type operating system, an IOS operating system or an Android operation system. Alternatively the devices may be based on information expressed in the audio domain. In the audio domain the user merely speaks and at the server end a voice responsive device translates the spoken information to appear in the message domain. The server S can include any of a variety of commercially available computers, servers or the like including or coupled to one or more supplemental magnetic, solid state or other conventional memory devices and suitable interfaces for the network N. The memory devices provide for the storage of plural databases which are employed in the coaching system of the invention.

The automated coaching system of the invention is provided to assist a user to maintain their lifestyle menu. The user's lifestyle menu may be derived from information provided by the user. For example the user will typically provide age, sex, height, weight information. Based on these parameters it is possible to estimate the user's basal metabolic rate. The user will also describe the user's current and desired physical activity levels, and if applicable, a desired weight reduction goal. With this information it is possible to calculate the user's recommended calorie intake. The user may also describe desired and undesired food types, recipes, menus, etc. The user may also describe desirable food modes such as (a) home based meal preparation, (b) use of carry home prepared meals and (c) patronizing restaurants. Using the calorie intake parameter and the other information provided by the user a menu can be designed which respects the user's food likes and dislikes and has the promise of achieving the user's goals. For example the menu may describe the type and amount of foods the user should eat for each day, for each meal as well as a snack or two. The menu may also include the source of the food, i.e., a) home based meal preparation, (b) use of carry home prepared meals and (c) patronizing restaurants, including identifying particular restaurants. Similarly, using the user's desired physical activity levels a physical activity menu can be designed which is based on the user's suggestions. The physical activity menu may specify the activity, duration and intensity of the activity the user should engage in as well the frequency or the day of the week the activity should be engaged in. The combination of the food and physical activity menus make up the lifestyle menu.

The user then engages in reporting on the extent the user actually carries out the food intake and physical activity specified in the lifestyle menu. Likewise the user reports on the user's weight at periodic intervals. With this information the lifestyle menu can be adjusted (the calorie level of the food intake or the physical activity or both) to guide the user to a lifestyle menu which will allow the user to realistically accomplish the user's goals. In other words, if the user overeats, or eats foods higher in calorie levels than on the menu or under performs on the physical activity menu, the user's weight reduction goal may not be realized. Rather than giving up, the lifestyle menu can be adjusted to more closely match the activity the user is likely to engage in. With the adjustment the user then continues to report on the extent to which the user actually achieves the suggestions on the adjusted lifestyle menu.

The automated coaching system is designed to respond to user reports of user concerns, disappointments, and successes related to adherence to the parameters of the lifestyle menu.

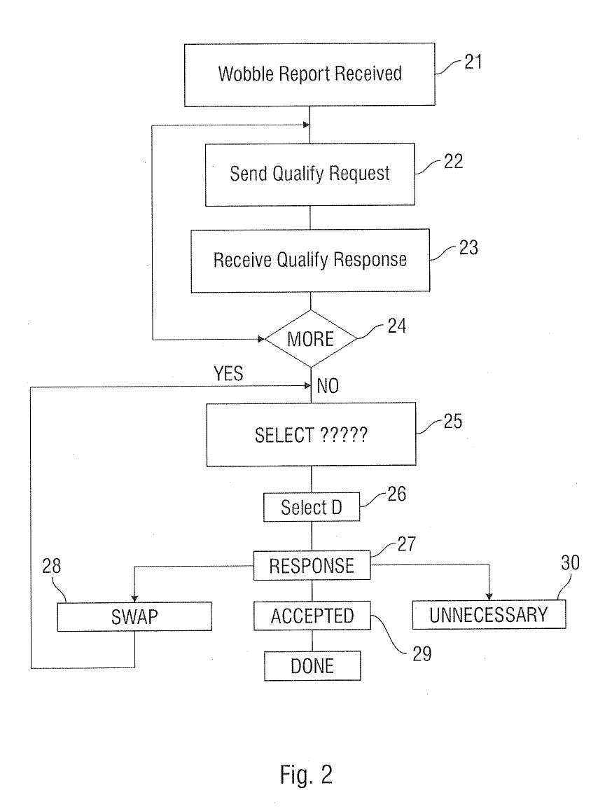

In the course of communicating with a system supporting a user's adherence to a lifestyle menu the user may report a wobble. In that case the automated coaching system registers the wobble report and performs the functions shown in FIG. 2. The wobble report is received and recognized at function 21. Function 22 is performed to transmit the user a request to qualify the wobble report. Wobble reports can be qualified with respect to several characteristics. For example the wobble report can be qualified with respect to type, location, time, etc.

Taking up a type qualification, the user may be allowed to choose a type of wobble from among options such as a craving, a lack of motivation, or a negative emotional state.

The type qualification may also be characterized with respect to location and/or the presence of others. In this case the user may choose a location such as “home alone”, “home with others”, or “at work.”

The time qualification may also be characterized with respect to time of day. This qualification can be performed in two ways. If the automated coaching system assumes that the wobble report is synchronous with the wobble then the time of day can simply be captured without further input from the user. However the user may be reporting a wobble earlier in the day, in that event the qualification can include a query to the user with respect to the time of day of the wobble.

The foregoing processing is effected by functions 22, transmitting a qualification request, function 23, receiving a qualification response from the user and function 24, to determine whether additional qualifications are available.

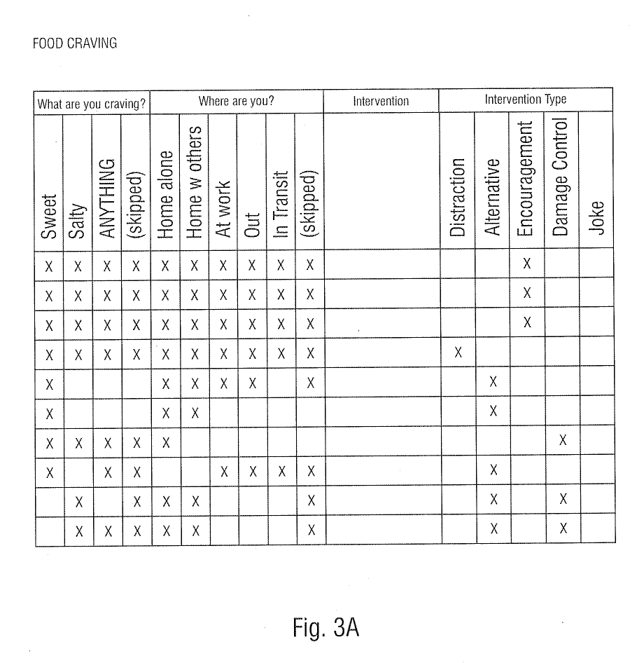

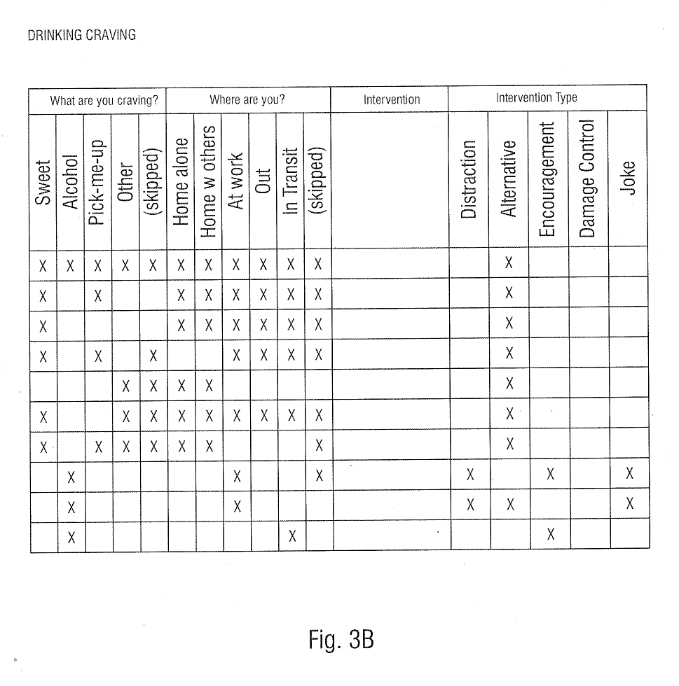

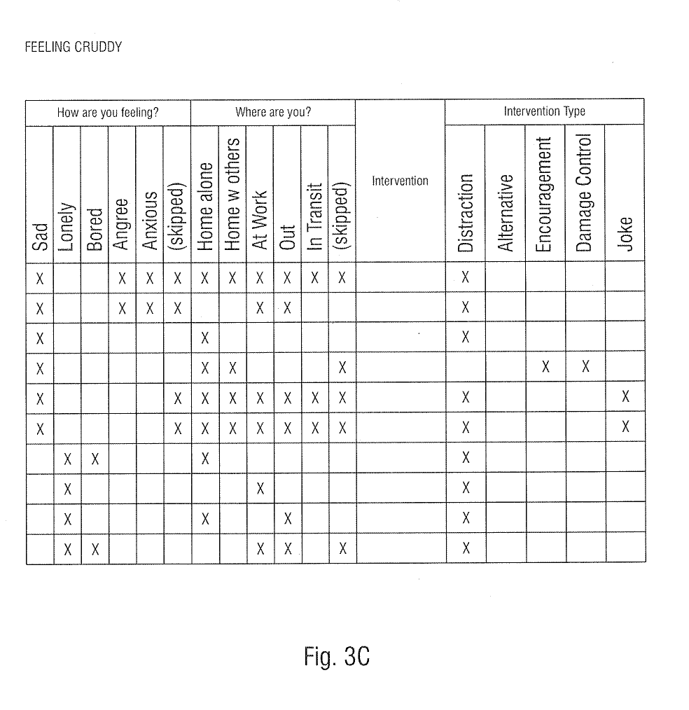

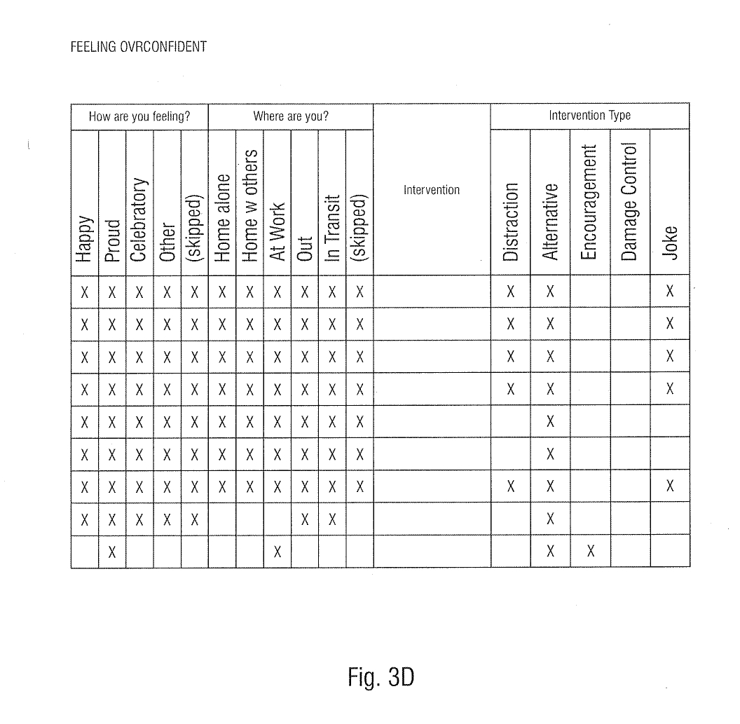

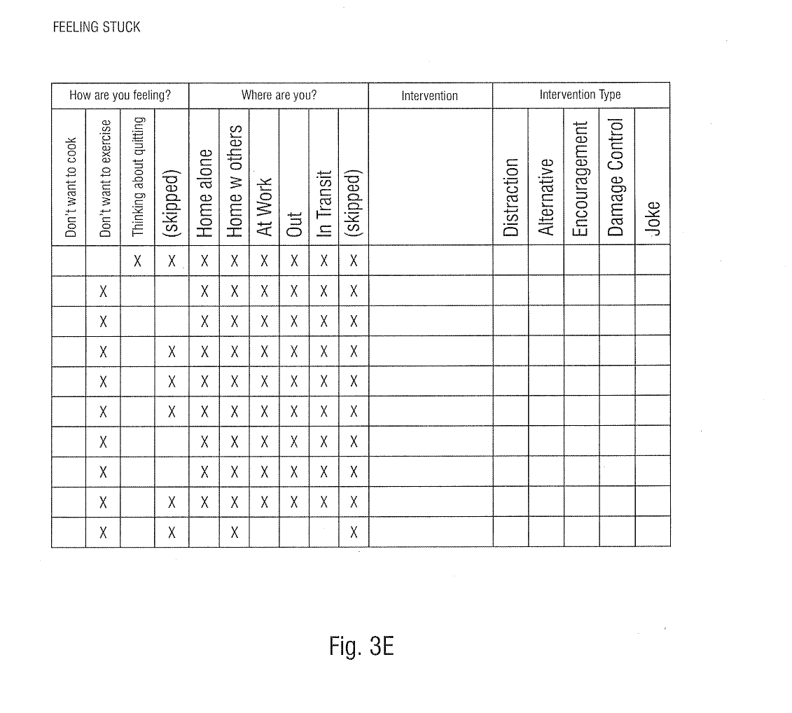

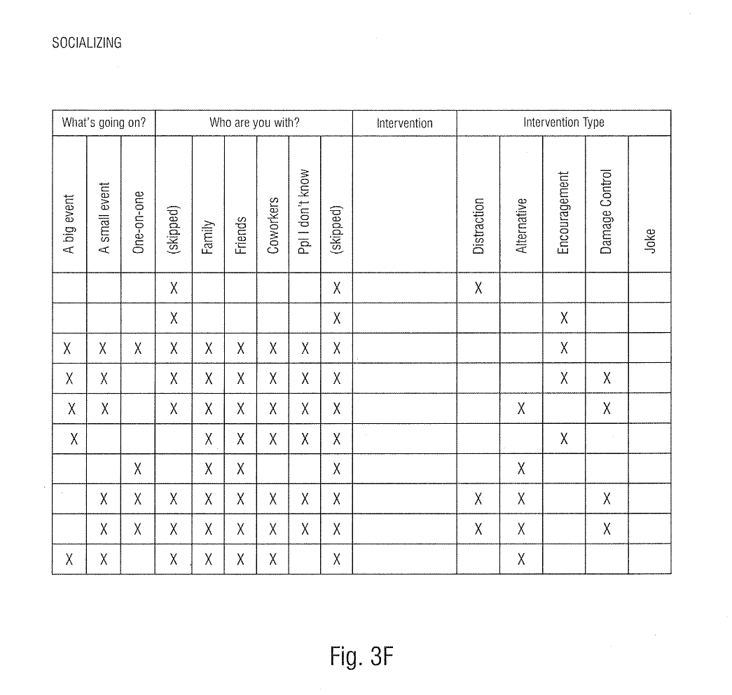

The automated coaching system includes a database of interventions, i.e., cognitive recommendations, behavioral recommendations, supportive statements and/or directive suggestions. The interventions will be sent to the user (function 25) in response to the receipt of the wobble message. The qualification information which is received from the user (function 23) is used to assist in selection of an appropriate intervention. FIGS. 3A, 3B, 3C, 3D, 3E, and 3F provide examples of an intervention table. The tables of FIGS. 3A, 3B, 3C, 3D, 3E, and 3F are is broken down into different sections as follows: “food craving” (FIG. 3A), “drink craving” (FIG. 3B), “feeling cruddy” (FIG. 3C), “feeling overconfident” (FIG. 3D), “feeling stuck” (FIG. 3E) and “socializing” (FIG. 3F). Each intervention is located on a different line of the table (although the actual interventions are not reproduced in FIG. 3). Each intervention is qualified by association with one or more of the characteristics heading columns located to the left and to the right of any specific intervention. The qualifications are grouped into three broad categories. The craving sections (FIG. 3A and FIG. 3B) as qualified among “What are you craving?”, “Where are you?” and “Intervention type”. The “What are you craving?” qualification for FIG. 3A is specific to foods, i.e., “Sweet”, “Salty”, “Anything” or “(skipped)”. “What are you craving” qualification for FIG. 3B is specific to drinks, i.e., “Sweet”, “Alcohol”, “Pick-me-up”, “other” or “(skipped)”. The qualifications located to the left of the interventions for the other sections are apparent from the particular figure. To the right of the intervention in each section of the table is another qualification devoted to the “intervention type”. In the examples shown in FIGS. 3A, 3B, 3C, 3D, 3E, and 3F, there are five different types of interventions, namely, “distraction”, “alternative”, “encouragement”, “damage control” and “joke”.

As will become apparent the qualifications to the left of the intervention characterize qualifications based on user input whereas the qualification to the right of the intervention are used by the automated coaching system to enable the user to indicate a preference for one type of intervention as will become clear in the following description.

When the user reports a wobble the system carries out the steps shown in FIG. 2. Function 22 is implemented by sending the user a qualify request. In the first instance that request would allow the user to select a section of the intervention table. Each qualification response of the user is stored in association with the user and other data received in connection with this transaction. After the user responds (function 23) the system might determine that there was a need for a further qualification (function 24) and so a further qualification request (function 22) is implemented. Following the receipt of this qualification (function 23) the system would determine (function 24) whether there was at least one additional available qualification. In the case that there is, the next qualification request (function 22) would depend on the user's response to the previous qualification request. Following receipt of the user response (function 23) the system would then determine (function 24) that there was no further need for qualification. Consequently the flow would effect “select intervention” (function 25). Using the user's prior responses and perhaps some further information (such as the data from prior transactions with this user) an intervention can be selected. If this was the user's first wobble there might be several interventions which would appear suitable; if the user had a history of prior interventions the system might have additional information from which an intervention selection could be made.

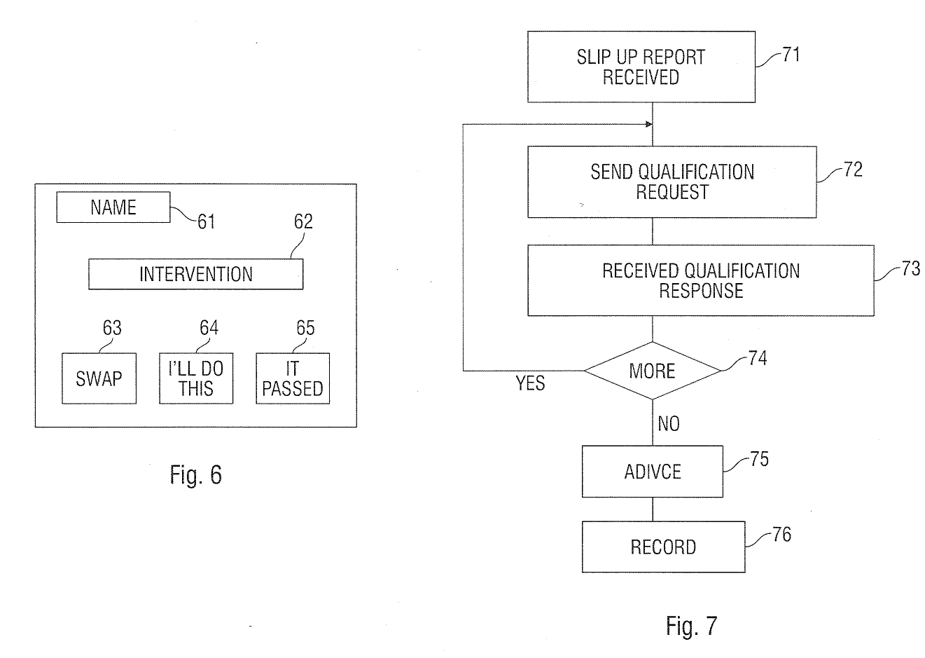

Referring again to FIG. 2, once an intervention is selected it is forwarded to the user (function 26). The system waits for a user response (function 27). FIG. 6 shows an example of a screen illustrating the transmission of the intervention to the user. As seen in FIG. 6 the screen includes five regions. A first region 61 shows the user name or other identification of the user. A second region 62 reproduces the selected intervention. Three additional regions 63-65 allow the user to respond to the intervention. In this example the system allows the user to request a swap (region 63) of the intervention; in other words the user can request the system to select a different intervention. Another response available to the user is the “I'll do this” (region 64) indicating the user has or will adopt the advice found in the intervention. Finally the user may also respond that the wobble has passed (region 65) and so no further action is necessary. The user may respond by selecting the appropriate response for example by positioning a pointer or cursor at the selected response, or by using touch (in the case the user has a touch sensitive device) to select the region corresponding to the appropriate response. The user device transmits a message indicating the user selected response to the server. These responses are reflected in FIG. 2 which indicates the received responses are recorded, note functions 28, 29 and 30. In the case the user response was to swap the intervention, the flow reverts to function 25 to select a new intervention. This can be implemented by simply avoiding transmission of the prior intervention. Preferably, however, the system notes the type of the prior intervention and selects a new intervention which is of a different type. This user interaction is also recorded to provide data for future user transactions.

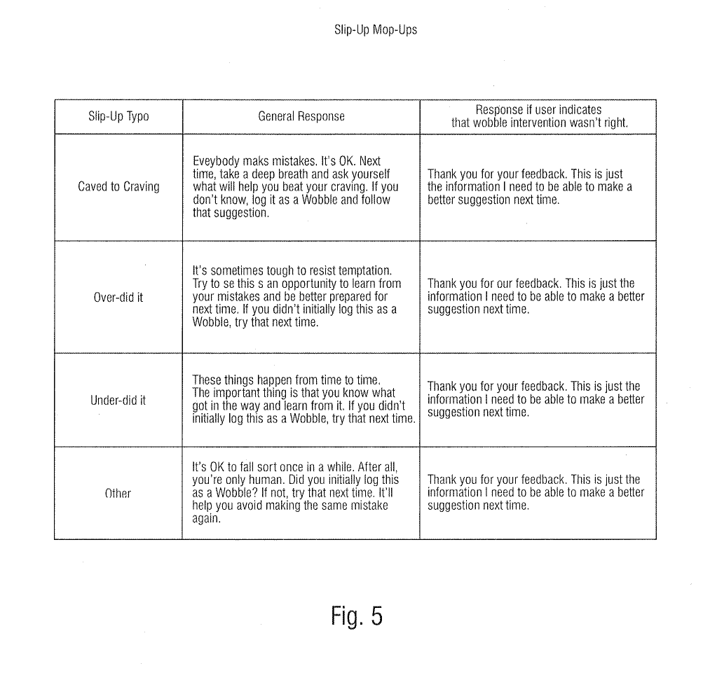

FIGS. 5 and 7 relate to the processing of slip-up reports. As noted above a slip-up represents the user's report of recognition that something has been done or failed to be accomplished which does not correspond to the user's lifestyle menu.

As seen in FIG. 7, when a slip-up report is received (function 71) a qualification request (function 72) is sent to the user. The qualification request or requests seek to establish the parameters of the slip-up, i.e, what was it (for example, overconsumption of a high-calorie food). Other qualification requests can establish:

why it happened (for example, lack of effort),

how the user was feeling at the time (for example, stressed),

who the user was with and where the user was,

when.

The user response to the qualification request is received at function 73. Function 74 determines if there are further qualification parameters, and if so, the flow returns to function 72 for another qualification request. When no further qualification is necessary, flow is directed to function 75 where the user receives slip-up intervention. Finally the data collected in this session is recorded (function 76) with respect to this user to assist in further coaching. Examples of slip-up interventions are illustrated in FIG. 5. It should be apparent that as more and more data is accumulated concerning this user's slip-ups, the slip-up advice may be modified to be more and more specific.

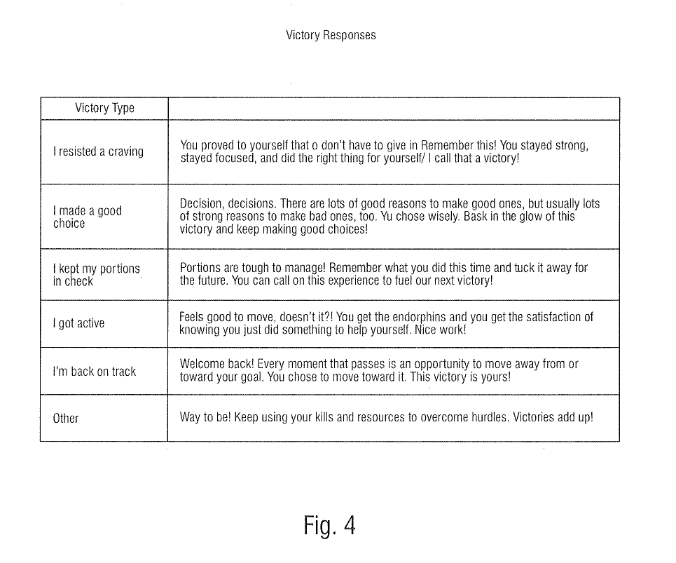

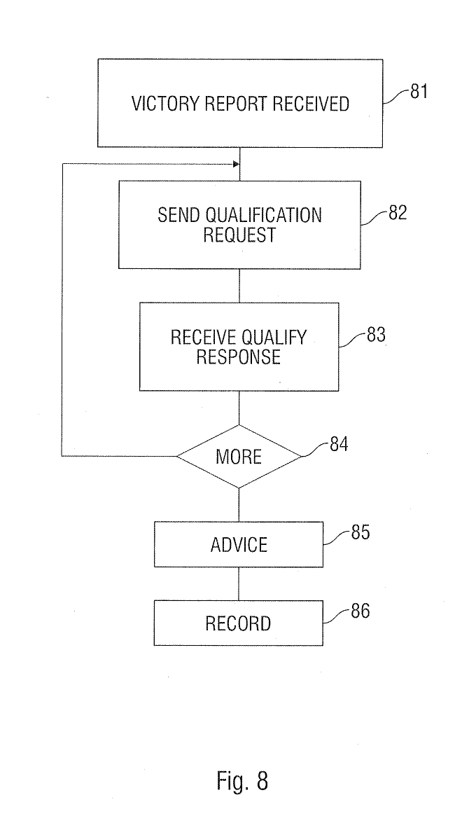

FIGS. 4 and 8 relate to the processing of victory reports. As noted above a victory represents the user's report of recognition that the user has overcome a perceived hurdle to maintaining the user's lifestyle menu.

As seen in FIG. 8 when a victory report is received (function 81) a qualification request (function 82) is sent to the user. The qualification request or requests seek to establish the parameters of the victory, i.e, what was it (for example, resisted a craving). Other qualification requests can establish:

what the user overcame (for example, a negative emotional state),

how the user did it (for example, willpower),

who the user was with and where the user was,

when.

The user response to the qualification request is received at function 83. Function 84 determines if there is further qualifications parameters, and if so, the flow returns to function 82 for another qualification request. When no further qualification is necessary function 84, flow is directed to function 85 where the user receives victory advice. Finally the data collected in this session is recorded (function 86) with respect to this user to assist in further coaching. Examples of victory interventions are illustrated in FIG. 4. It should be apparent that as more and more data is accumulated concerning this user's victories, the victory advice may be modified to be more and more specific.

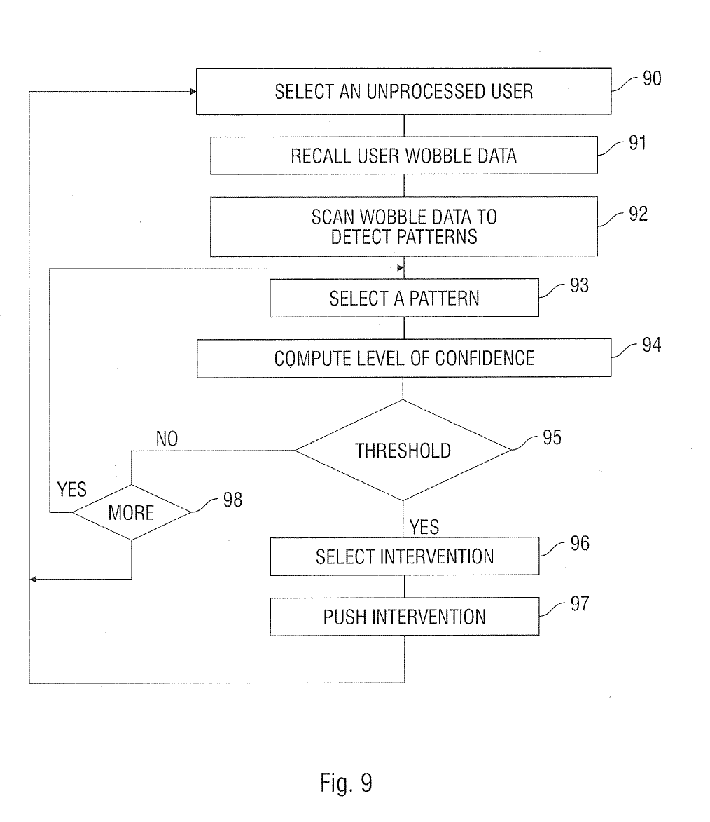

The foregoing description is limited to automated coaching which is provided synchronous with user reported events. However the automated coaching system of the invention can also act proactively. i.e., without a synchronous user stimulus. FIG. 9 shows one example of a proactive procedure. The procedure relies on data which is collected in connection with user wobble reports. The wobble data for any one user can be searched to detect patterns. For example time of day and wobble type can be scanned to detect a pattern (does a particular wobble frequently occurs at the same time of day). The data will also allow a level of confidence to be computed. A pattern with a confidence level exceeding a threshold can be acted on preemptively by selecting an intervention (based on a predicted wobble) and transmitting the preemptive intervention to the user.

The procedure of FIG. 9 may be executed on a timed basis. The procedure is initiated by selecting a user who has not yet been processed (function 90). The wobble data related to that user is recalled, function 91. The recalled wobble data is then scanned, function 92 to detect any patterns. One useful pattern to look for is a correlation between wobble type and time of day. Function 93 then focuses on a particular pattern which may have been detected in function 92. Function 94 then uses the recorded data to compute a level of confidence for that pattern. Function 95 then tests the computed confidence level against a threshold. If the level of confidence exceeds the threshold then function 96 is performed to select an intervention. Intervention selection is based on the pattern which had been selected. Then function 97 pushes the intervention to the user. Flow then returns to select a user not yet processed on this iteration of the procedure. If the pattern selected in function 93 has a level of confidence less than the threshold then flow proceeds to function 98 to determine is there are any other detected patterns (function 92). If so functions 94 and 95 are preformed as described. On the other hand if all the patterns detected at function 92 have been processed then the flow returns to select a user not yet processed on this iteration of the procedure.

While the description of the foregoing preemptive procedure is concerned with wobble data in fact a similar procedure can be carried out with victory data or slip-up data and also with combinations of victory, slip-up and wobble data.

1. An automated coaching system to assist a user engaged in a program for health improvement comprising:
a receiver for receiving a moment defining message generated by a user,
a collections of moment responses,
a transmitter for transmitting at least one qualification message to the user in response to receipt of said moment defining message, said qualification message requesting qualification information respecting the moment represented in the moment defining message,
a qualification receiver for receiving a qualification response from the user,
a selector responsive to said receiver and said qualification receiver for selecting a particular one of said moment responses in dependence on the moment defining message and the qualification response, and
a forwarder for forwarding said selected response to the user.

2. The system of claim 1 wherein the qualification response includes one of a moment defining response, a moment timing response or a moment locating response.

3. The system of claim 1 wherein the collection of moment responses includes a plurality of different groups of moment responses, each group of moment responses including responses with a characteristic which differs from characteristics of other group of moment responses.

4. The system of claim 3 wherein said groups of moment responses include one or more of cognitive interventions, behavioral interventions, supportive statements, and directive advice.

5. An automated coaching system to assist a user engaged in a program for health improvement comprising:
a receiver for a moment defining message generated by a user, where the message may define one of plural types of moments,
a plurality of collections of moment responses including at least one collection of moment responses for each of the plural types of moments,
a selector responsive to said receiver for selecting a particular one of said collections of moment responses in dependence on the particular type of moment message received and for using said moment defining message for selecting a response from the particular collection, and
a forwarder for forwarding said selected response to the user.

6. The coaching system of claim 6 wherein the moment may be one of a wobble, a victory or a slip up.

7. The coaching system of claim 6 wherein the selector include provision for retaining a number of prior moment defining messages from the user, each prior moment defining message associated with a response which had been forwarded to the user by the forwarder in response to the prior moment defining message.

8. An automated coaching system to assist a user engaged in a program for health improvement comprising:
a receiver for receiving wobble defining messages generated by users,
a collections of wobble interventions,
a qualification receiver for receiving wobble qualification responses from users,
a data base storing, for each of plural users, qualification responses and wobble defining messages,
a pattern detector for scanning data from said database to detect at least one pattern in said stored data, and
a selector responsive to said pattern for selecting a particular one of said wobble interventions, and
a forwarder for forwarding said selected wobble intervention to a user.
